(19) United States
(12) Patent Application Publication
(10) Pub. No.: US 2026/0127866 A1
(43) Pub. Date: May 7, 2026

(54) SYSTEM AND METHOD FOR LOW-POWER OBJECT DETECTION WITH REDUCED FALSE POSITIVES

(71) Applicant: Digital Monitoring Products, Inc., Springfield, MO (US)

(72) Inventor: Rick A. Britton, Springfield, MO (US)

(73) Assignee: Digital Monitoring Products, Inc., Springfield, MO (US)

(21) Appl. No.: 19/379,507

(22) Filed: Nov. 4, 2025

Related U.S. Application Data
(60) Provisional application No. 63/716,298, filed on Nov. 5, 2024.

(51) Int. Cl. G06V 10/776; G06T 3/40; G06V 10/94; G06V 20/40

(52) U.S. Cl. CPC G06V 10/776; G06T 3/40; G06V 10/95; G06V 10/955; G06V 20/40

(57) ABSTRACT

Systems and methods for low-power object detection with reduced false positives in video analytics are disclosed. A video analysis system receives a video stream, isolates frames, and executes a first object-detection algorithm to identify a potential object in the frame. The frame is reduced in size to focus on the object and is passed to one or more additional algorithms that confirm detection within progressively smaller regions of interest. Object detection is confirmed based on agreement or composite confidence scores among the algorithms. By limiting analysis to relevant frame regions, the system improves detection accuracy while substantially reducing processing time, energy consumption, and false detections.

### CROSS-REFERENCE TO RELATED APPLICATIONS

This application claims the benefit of U.S. Provisional Application No. 63/716,298, filed November 5, 2024, the disclosure of which is hereby incorporated herein in its entirety by reference.

### BACKGROUND

Processing video recordings and/or data streams to detect and identify objects within the video stream is a resource-intensive task. Current video processing hardware typically uses multiple processors, with multiple cores within each processor, to analyze video data and determine or detect one or more objects within one or more video frames of the data stream. As the size and resolution of modern cameras and image sensors continue to increase, the volume of data to be analyzed for object detection has grown exponentially, placing an ever-increasing demand on available computing and electrical power resources.

Current methods of processing and analyzing video data to detect objects typically involve a series of steps in which each video frame is treated as an individual image, and objects within each of those individual frames are identified and classified. For example, captured and recorded (or live) video data streams may be split into multiple individual frames, with each frame processed and analyzed as a standalone image to detect the presence of an object or objects. Because the processing of every frame takes time and consumes additional power, the number of individual frames actually analyzed in any given application may vary. For example, every frame of the stream’s multiple frames may be analyzed, frames may only be selected and analyzed periodically, or only specifically selected frames may be processed. However, in continuous-monitoring video environments - such as security systems, autonomous vehicle navigation systems, or industrial robotic or machine-vision equipment - image processing must typically be performed continuously, with every frame analyzed, thus requiring electrical power and dedicated computer processing hardware for the entire time that the system is up and operational.

While pre-processing each frame to be further analyzed can streamline the analysis process to some extent, pre-processing - such as resizing the image/frame, normalizing the frame data to adjust pixel values to a standard range, and adjusting the color (if applicable) to match a desired color scale, such as RGB or grayscale - the computing power (and thus the corresponding electrical power) required to process video data to identify and detect one or more objects in a single or series of video frames is significant. This high computing demand and corresponding power consumption leads to increased heat generation and reduced operating life, especially for battery powered or heat sensitive devices.

Furthermore, once an object is initially detected or identified within a video frame, that specific frame must typically be analyzed multiple times in order to confirm the detection of an object and to ensure that the initial detection is not a false detection (i.e., a false positive). Conventional video analysis systems thus often execute the same, or similar, object detection algorithms across the entire video frame for verification, even though only a portion of the frame may actually contain a potential object of interest. This redundant re-analysis of areas of the frame in which an object was not detected requires substantial processing time and power without providing a proportional improvement in the accuracy of the detection.

These limitations are particularly troublesome in power limited environments, such as battery powered surveillance cameras, unmanned aerial vehicle cameras, drones), vehicle navigation systems, and embedded Internet-of-Things (IoT) vision devices, where computing power must be balanced against available electrical power resources in order to maximize operational time.

Thus, it can be seen that there remains a need in the art for improved systems and methods for detecting objects in video data streams that provide high object detection reliability while reducing the computational and electrical power requirements to do so.

### SUMMARY

Embodiments of the invention are defined by the claims below, not this summary. A high-level overview of various aspects of the invention is provided here to introduce certain concepts that are further described in the detailed description section below. This summary is not intended to identify key or essential features of the claimed subject matter, nor is it intended to be used in isolation to determine the scope of the claimed subject matter.

The present invention is directed to systems and methods for minimizing false positives and reducing power consumption for video-based object detection. Known object detection systems typically analyze entire video frames multiple times, using multiple algorithms to confirm the presence of an object, resulting in significant computational and electrical power demand. The systems and methods of the present invention improve the efficiency of the analysis by progressively limiting the analysis to smaller regions of interest within the frame, using multiple object-detection algorithms executed in sequence, and dynamically managing system resources based on analysis conditions.

In one exemplary embodiment, a video analysis system receives a video stream, isolates individual frames from the stream, and executes a first object-detection algorithm to identify an object within a frame. The portion of the frame containing the detected object (i.e., a reduced frame) is then passed to a second object-detection algorithm that confirms or refines the detection. Each subsequent algorithm thus analyzes a smaller, more focused region of the original video frame, thereby reducing redundant computation on the entire frame and improving overall processing time. Detection of an object is confirmed based on agreement or threshold confidence level among the multiple algorithms.

In further embodiments, the number and type of detection algorithms executed may be chosen dynamically according to various criteria, such as measured confidence levels, the complexity of the image captured in the video frame, or power conditions.

Thus, the disclosed systems and methods increase the reliability of object detection while significantly decreasing the computational and electrical power required for continuous or large-scale video analytics. The claimed system and method are well suited for use in security systems, embedded devices, battery-powered devices, and other power-constrained environments where maintaining detection accuracy with reduced computational overhead is required.

### DESCRIPTION OF THE DRAWINGS

Illustrative embodiments of the invention are described in detail below with reference to the attached drawing figures, and wherein:

FIG. 1 is a block diagram of a low-power video analysis system for object detection with reduced false positives in accordance with an exemplary embodiment of the present invention.

FIG. 2 is a flow diagram of an exemplary method for low-power video analysis for object detection with reduced false positives in accordance with an exemplary embodiment of the present invention.

FIG. 3 is a depiction of a successively reduced video frame focusing on a detected object in accordance with an exemplary embodiment of the present invention.

FIG. 4 is a flow diagram of an algorithm selection process for implementation by the video analysis system of FIG. 1 in accordance with an exemplary embodiment of the present invention.

### DETAILED DESCRIPTION

The subject matter of select embodiments of the invention is described with specificity herein to meet statutory requirements. However, the description itself is not intended to necessarily limit the scope of claims. Rather, the claimed subject matter may be embodied in other ways to include different components, steps, or combinations thereof similar to the ones described in this document, in conjunction with other present or future technologies. Terms should not be interpreted as implying any particular order among or between various steps herein disclosed unless the order of individual steps is explicitly described and required. The terms “about”, “approximately”, or other terms of approximation as used herein denote permissible deviations from the exact value in the form of changes or deviations that are insignificant to the function.

As used herein, the term "module" refers to a set of software and/or hardware components configured to perform specific tasks. A module may be implemented as a software application, function, subroutine, library, or service executing on a processor-based computing device, such as a server, desktop, laptop, mobile device, or other computing platform. A module may also be implemented as a combination of software instructions and associated hardware circuitry, such as a field-programmable gate array (FPGA), application-specific integrated circuit (ASIC), or other dedicated processing hardware.

And, as used herein, the term "real-time" refers to the execution of computational processes, including video analysis, parameter selection, and notification at a speed and efficiency that enables immediate interaction without perceptible delay to the user. In this context, "real-time" denotes a level of rapid processing that would be infeasible for a human to perform manually within a practical timeframe.

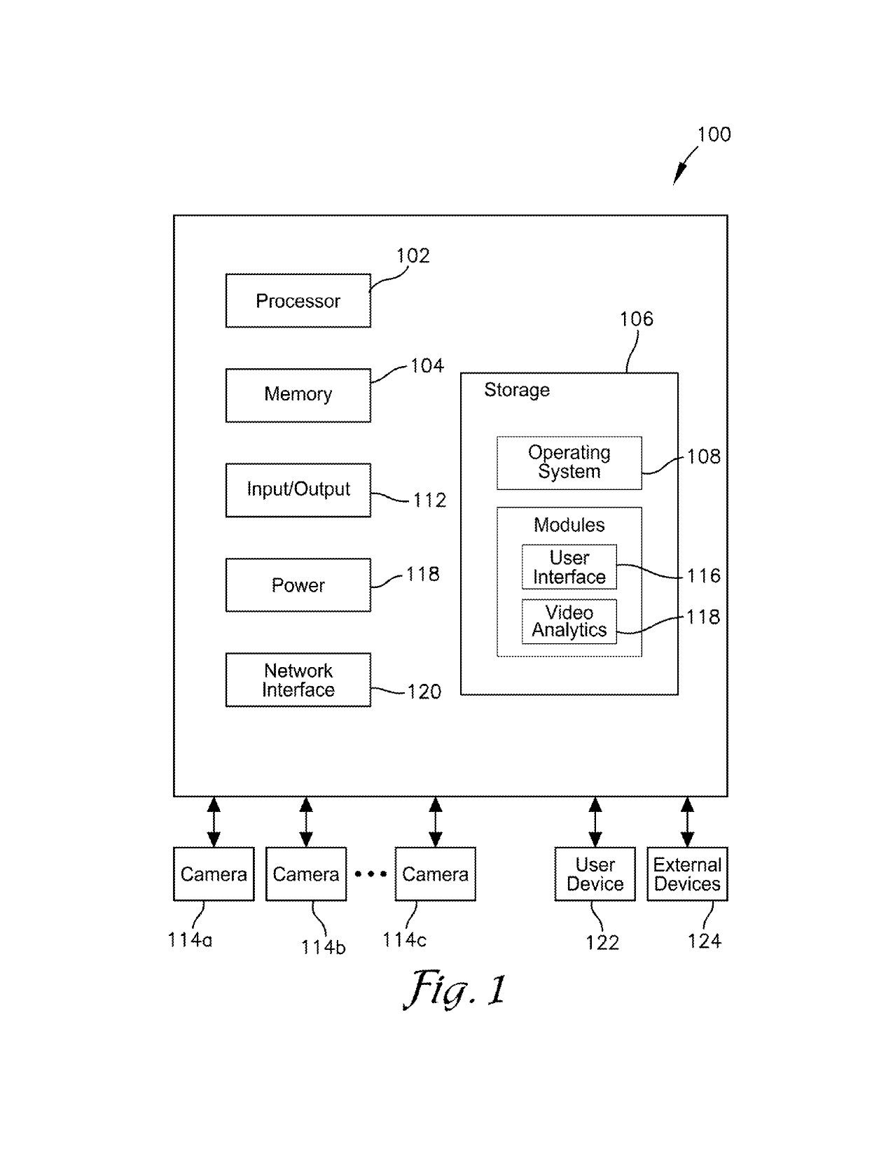

Looking first to FIG. 1, a low-power video analysis system 100 for reduction of false positives in object detection in accordance with an exemplary embodiment of the present invention is depicted. The video analysis system 100 includes hardware configured to execute one or more software modules, processes, or algorithms for analyzing video data and/or video streams as described herein. It should be understood that the components and configurations illustrated in FIG. 1 are exemplary, not limiting, and that various configurations, such as consolidation or separation of individual hardware components may be employed without departing from the scope of the present invention.

Looking still to FIG. 1, the video analysis system 100 includes at least one processor 102 operable to execute computer program instructions. The processor 102 may comprise a central processing unit (CPU), a graphics processing unit (GPU), or combinations thereof, and may include one or more cores configured to perform parallel or sequential instruction execution. Processor 102 is in communication with a memory 104 that provides volatile and/or non-volatile storage for program instructions and data during execution of various modules or algorithms. Memory 104 may include random-access memory (RAM) or other high-speed temporary storage technologies suitable for the storage of data structures, video frames, video data, and system parameters during the execution of instructions by the processor 102.

A storage device 106 provides non-volatile storage for program instructions, video data, video streams, and system parameters. Storage device 106 may comprise any non-volatile memory or storage device as known in the art, such as hard disc drives, solid-state drives (SSD), flash drives (e.g., USB drives), memory cards, and other magnetic or optical storage devices. Storage device 106 preferably stores an operating system 108, one or more executable software modules 110, video data and video streams either recorded from system cameras or transferred or copied from other devices, and corresponding analysis results and information.

Operating system 108 provides a software interface between the hardware components of the video analysis device 100 and higher-level software modules and components as will be described in more detail herein, and manages system resource allocation, memory and storage access, and communication with any peripheral devices.

The video analysis system 100 preferably includes one or more input/output (I/O) interfaces 112 configured to enable and manage data transfer and communication with devices external to the video analysis system. For example, the I/O interfaces 112 may include network interfaces and peripheral controllers to allow communication with external networks, memory and storage devices, video capture interfaces, external graphics processing units (GPUs), and/or peripheral controllers for wired or wireless communication between the video analysis system 100 and external devices. Thus, in one exemplary embodiment, the I/O interfaces may 112 receive video streams from one or more external cameras 114a, 114b, 114c, such as security cameras, in communication with the video analysis system and record or store the video streams, and transmit analysis results, alerts, or object detection confirmation notifications to external systems, databases, or user interfaces.

A system bus preferably interconnects the processor 102, memory 104, storage 106, and I/O interfaces 112, allowing signal and data communication between the system components. The bus may include one or more physical or logical communication channels and may be configured to communicate using analog, digital, or both, protocols over internal system buses and/or peripheral connections such as PCI, PCIe or other similar bus architectures.

In some embodiments, the video analysis system 100 may further include dedicated power management circuitry 118 configured to monitor system activity and parameters and to control power delivery to the processor 102, memory 104, and/or other internal components. The power management circuitry 118 may, for example, reduce clock speeds, deactivate idle components, adjust operating voltages in response to variations in analysis demand, or take other actions to reduce power consumption of the video analysis system 100, thus reducing energy consumption during low-demand periods.

Network interface 120 is configured to enable communication between the video analysis system 100 and external computer or server systems, such as cloud-based analytic systems. In some embodiments, the video analysis system may, via the network interface 120, transmit video streams, video data, frame data, partially processed frame data, detection results, or control commands to external processing systems for simultaneous co-processing or external data processing.

It should be understood that in some embodiments the video analysis system 100 may be implemented as an embedded processing unit, such as being contained within a camera housing (e.g., cameras 114a, 114b, 114c), may be implemented as a discrete system connected to one or more cameras or imaging sensors, or may be implemented as a distributed system across multiple devices or computing devices. The configuration of the video analysis system of FIG. 1 is thus representative, in other embodiments the system may be adapted to various implementations of the hardware and/or software components as required for a specific application.

In operation, the processor is operable to execute computer program instructions to implement the functionality of a user interface module 116 to allow users to remotely access and interface with the system 100 using various user devices 122 such as computers, smart phones, and the like. Users may access stored video streams, monitor real-time video streams from the cameras 114a, 114b, 114c, and access video and analytic information stored on the system.

Video analytics module 126 is operable to isolate video frames from an incoming or stored video stream for analysis, and to apply one or more object-detection algorithms on the isolated frames. The video analytics module 126 includes functionality to focus or reduce the size of each frame to a smaller, reduced frame corresponding to the region in which an object has been detected by a prior algorithm as will be described in more detail below.

Preferably, the video analytics module 126 executes multiple object-detection algorithms in succession, with each algorithm independently analyzing the region of interest received from the previous algorithm. Each subsequent algorithm thus processes a progressively smaller portion of the original video frame, thereby reducing the demand for computing resources and the corresponding power consumption needed to perform the analysis. Once a predetermined number of algorithms have been executed, or when successive algorithms sufficiently confirm consistent detection of an object, the video analytics module 126 confirms the detection.

In different embodiments of the present invention, the number and type of algorithms executed by the video analytics module 126 may be varied by user configuration or may be automatically determined by the module itself based on factors and parameters such as video frame complexity, motion level, or scene context. In a preferred embodiment, at least two distinct algorithms are executed sequentially to allow a secondary confirmation of an initial detection made by a first algorithm.

Communication with external systems or devices, such as cameras 114a, 114b, 114c or other external devices 124 may be via wired or wireless connection. In some embodiments the system 100 may transmit video analysis results, alert notifications, or processed frame data to external devices 124 for storage or to user devices 122 for viewing.

It should be understood that the arrangement of components and modules as illustrated in FIG. 1 is exemplary, and that the modules as depicted may be implemented in software, hardware, or any combination thereof. Functional components of the modules may be consolidated or distributed among different devices as appropriate for the specific application and environment in which the system is deployed.

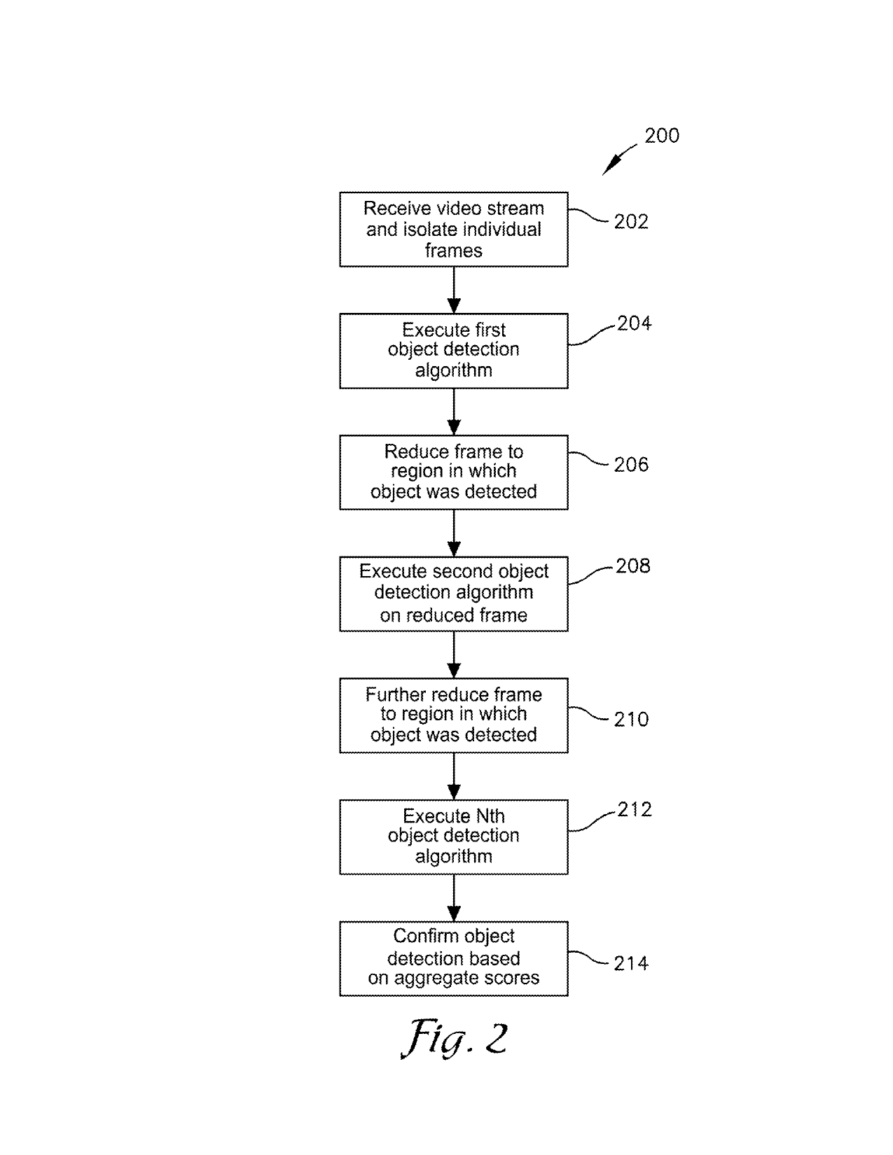

Turning to FIG. 2, a flow diagram of a method for low-power reduction of false positives in object detection in accordance with an exemplary embodiment of the present invention is depicted generally as 200. The method 200 is preferably executed by the video analytics module 126 of the video analysis system 100 described above. While the method 200 is depicted as a series of discrete operations, it should be understood that the order of execution of steps may vary, that certain steps may be combined or omitted, and that additional steps may be included depending on the requirements for implementation in specific scenarios or environments.

At block 202, the system receives a video stream from one or more cameras and isolates individual frames from the received video stream for analysis. The isolation of individual frames allows each of those frames to be processed as an independent image and provides the basis for subsequent object detection.

At block 204, the system executes a first object-detection algorithm to detect one or more objects within the isolated video frame. The first algorithm may employ any known object detection technique, such as feature-based or neural-network based detection, and preferably outputs a detection result and a confidence ranking or score associated with the detected or identified object. An object, as that term is used herein, may be any of a person, animal, item, or anything visible or detectable by the camera or video capture device.

Upon detection of an object within the video frame by the first algorithm, at block 206 the frame undergoing analysis is reduced in size to include only the region in which the object was detected. With the reduced frame size, subsequent analysis and detection will be performed on a smaller detection area, thus reducing the computing power (and corresponding electrical power) and time required for further processing.

At block 208, the reduced-size frame generated by the first algorithm is analyzed by a second object-detection algorithm. The second algorithm independently evaluates the reduced-size frame to confirm or deny the prior detection of an object within the reduced-size area, along with a confidence score. In preferred embodiments, the second object-detection algorithm is a different algorithm than the first algorithm. In other embodiments, the second algorithm may be the same algorithm as the first algorithm, but in this subsequent analysis, the algorithm will be focused on the reduced-size frame.

At block 210, when the second algorithm identifies an object within the reduced-size frame, the frame may again be reduced or focused to include only the smaller region corresponding to the detection area determined by the second algorithm.

At block 212, the second reduced-size frame output from the second algorithm may be passed to an n^{th} object-detection algorithm for further confirmation. The n^{th} algorithm may similarly employ different detection logic, processing precision, or feature extraction techniques from either the first or second algorithms to provide additional validation that an object is detected in the frame being analyzed, along with a confidence score. Each successive algorithm thus operates on a reduced-size, or subset of the preceding frame and/or applies different or more focused analysis techniques, thus minimizing redundant computation and corresponding cumulative power consumption.

At block 214, detection of an object is confirmed based on the aggregated results of the executed algorithms. Confirmation that an object has been detected may be determined by agreement among a specified number of algorithms that an object was detected in the frame, by a composite confidence score threshold (e.g., a sum or average of the confidence scores of each executed algorithm), or by other user-defined criteria. The algorithm preferably will store the confirmed detection result, along with the corresponding frame(s) identification for later retrieval or further analysis.

In some embodiments, the number and selection of object-detection algorithms employed in method 200 may be automatically determined by the video analytics module 126 based on the application or operating context – for example, security camera detection, autonomous vehicle operation, etc. Parameters such as frame complexity, motion level, illumination conditions, or available processing power may also be used to dynamically adjust the number of detection algorithms executed. In other embodiments, a user may define the number and type of algorithms to be applied.

Because each detection algorithm in the object detection sequence operates on a progressively smaller frame region, subsequent analyses by each successive algorithm requires less computing time and electrical power. And, using multiple, distinct algorithms for each successive analysis increases the confidence of accurate object detection and reduces the likelihood of reporting false positives.

The method thus provides efficient and accurate object detection and reduces the likelihood of false positives, while simultaneously reducing the computing resources and corresponding electrical power required to perform the analysis.

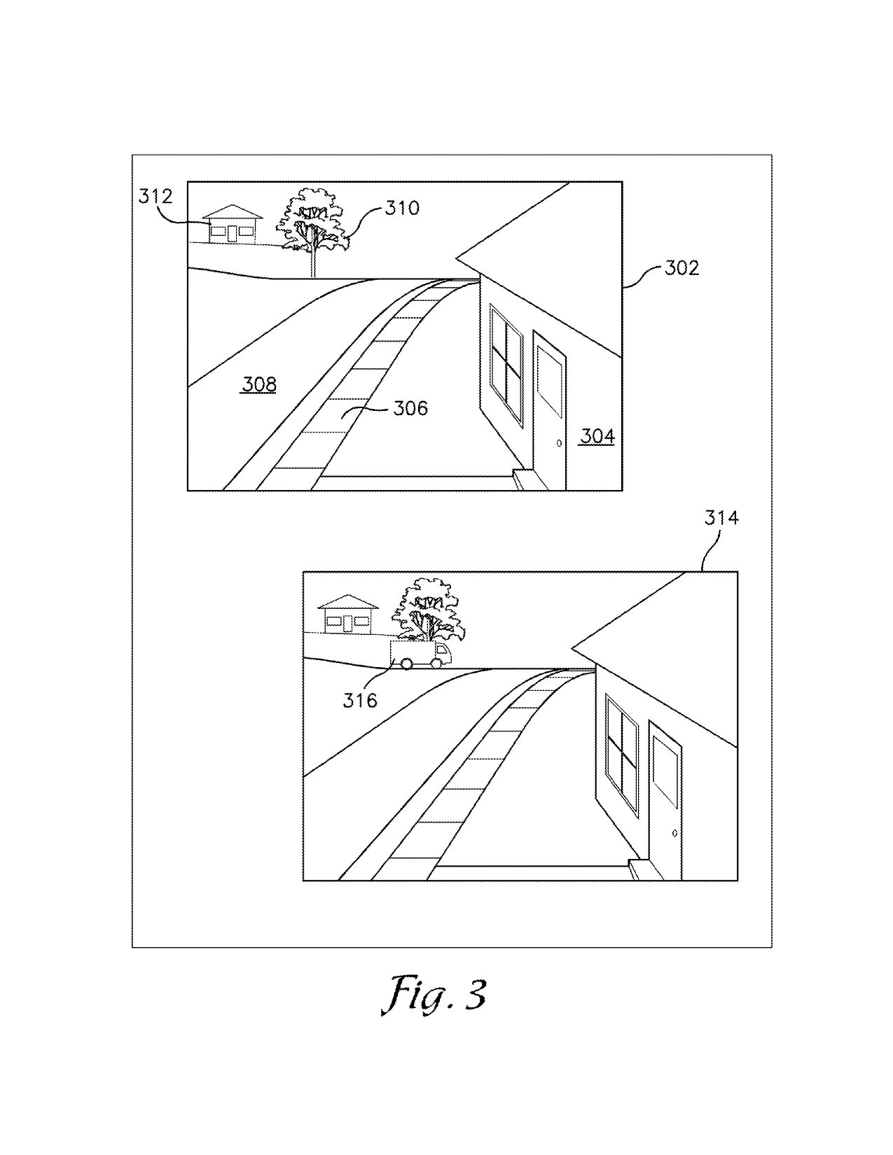

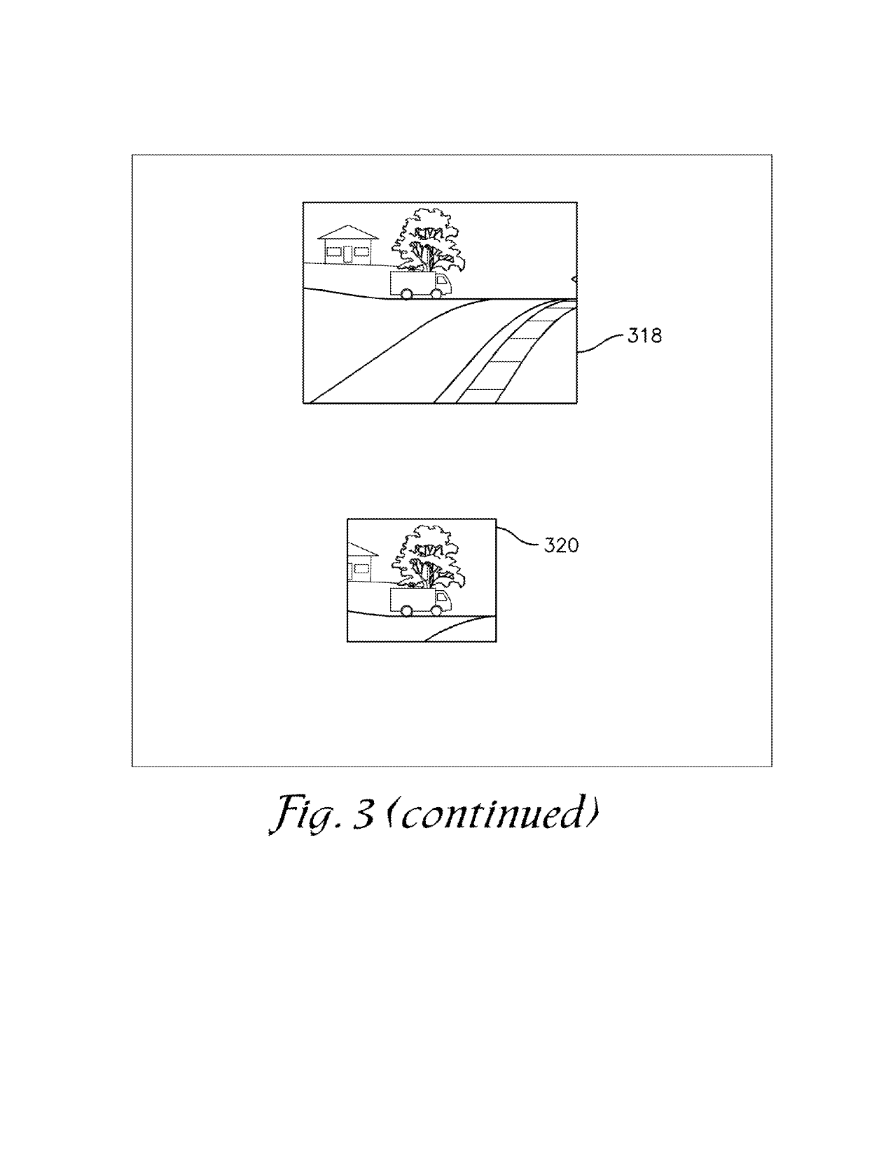

Turning to FIG. 3, and with reference back to FIGS. 1 and 2, the reduced-frame analysis implemented and performed by the system and method of the present invention is shown. As seen in FIG. 3, an original video frame 302 is depicted, with the image in the frame showing the field of view of a video camera (such as from a video stream originating from a security camera 114a, 114b, 114c as shown in FIG. 1). As seen in frame 302, the image depicted is the “normal” view of the camera, i.e., everything seen in the view is expected to be there, such as the house 304, sidewalk 306, street 308, tree 310, and distant building 312.

In preferred embodiments, the system 100 may normalize incoming video frames being analyzed to account for these normal, expected objects in the field of view so that the object detection algorithms will not trigger or detect those expected items as objects. Normalization may be accomplished by pre-processing the video frames before analysis by any of the object detection algorithms, may be accomplished within the object detection algorithms themselves, or may be accomplished by other methods as known in the art.

With the normal view of the camera’s field of view established in frame 302, as now seen in frame 314, an object (in this example, a truck, 316) has entered the field of view of the camera and is now present in the captured video frame (it should be understood that the frame 314 is taken from the same video camera, with the same field of view, as normal frame 302).

Upon execution of a first object-detection algorithm (as described in step 204 of FIG. 2 above), the first algorithm detects the truck 316 in the video frame 314 and (as described in step 206 of FIG. 2 above) reduces the video frame to a smaller size, resulting in a reduced-size video frame 318. As also described above, the first object-detection algorithm preferably assigns a confidence score to the certainty of the detection, for example a percentage or numerical confidence that the detected object (in this case truck 316) is in fact an object that was not present in the previous normal frame.

As can be seen in comparing frames 314 and 318, the reduced-size frame 318 eliminates over half of the original frame, resulting in a much smaller area to be analyzed by subsequent object-detection algorithms – in this case the entire house 304 and much of the sidewalk 306 and street 308 present in the original field of view frame 302 of the camera have been eliminated. Thus, a subsequent object detection algorithm analyzing the reduced-size frame 318 will be analyzing a smaller frame and a correspondingly reduced amount of video information.

Continuing with reference to FIG. 3, upon execution of a second object-detection algorithm (as described in step 208 of FIG. 2 above), the second algorithm detects the truck 316, assigns a confidence score or value to the detection, and generates a further reduced size frame 320 which eliminates additional extraneous information from the frame and focuses more specifically on the area of the frame in which the detected object (truck 316) appears.

As can be seen, the further reduced-size frame 320 is smaller that its predecessor frame 318, and thus will require even less computing resources and electrical power for further analysis (if needed) by subsequent object detection algorithms.

Thus, FIG. 3 graphically illustrates the iterative refinement and reduction in size of subsequent video frames during the object-detection analysis. As the frame size is reduced, the corresponding amount of computing resources and electrical power to provide those computing resources is correspondingly reduced. In combination with the iterative assignment of confidence scores to each analysis, the system and method of the present invention thus provide low-power object detection with reduced false positives as compared to conventional video analysis systems.

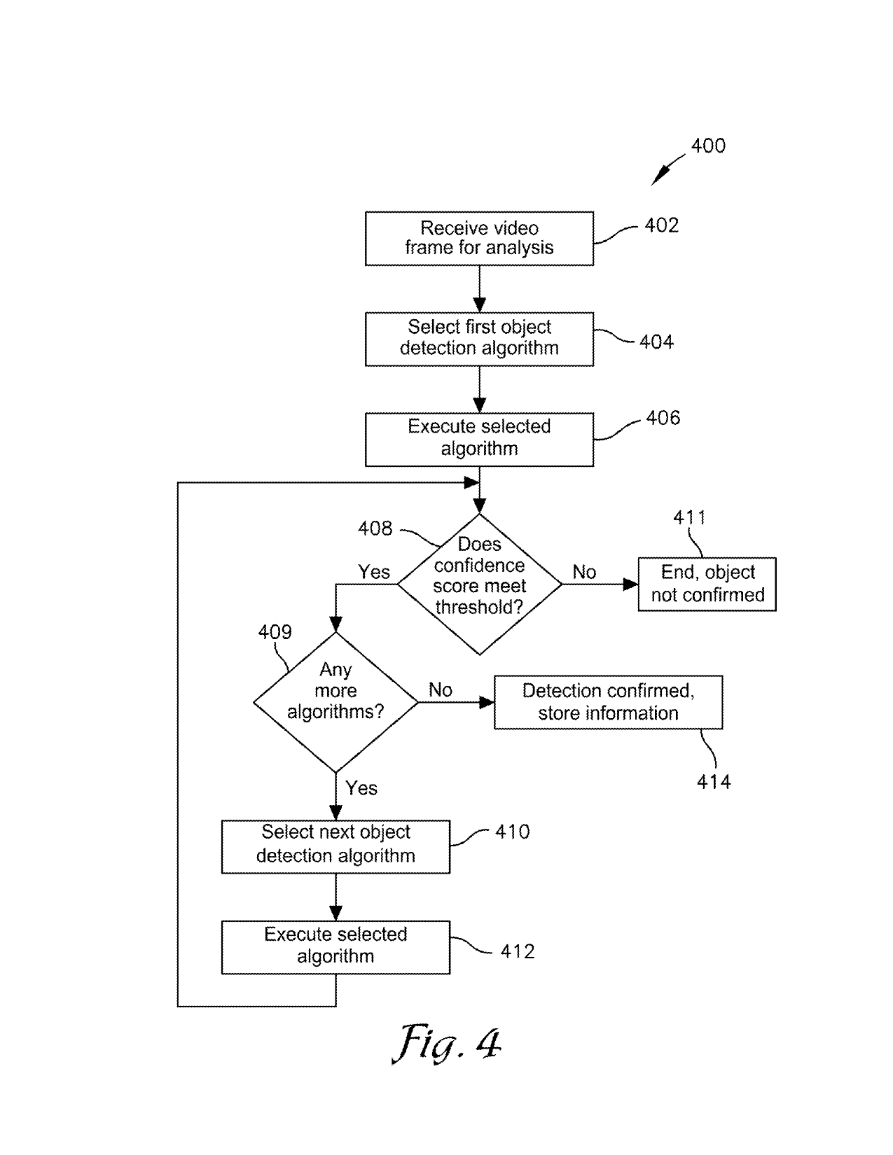

Turning now to FIG. 4, a flow diagram of an algorithm selection process 400 in accordance with exemplary embodiments of the present invention is depicted. The selection process 400 preferably operates similarly to the object detection method as described above with respect to FIG. 2, except the type of object-detection algorithms and the sequence in which the algorithms are successively applied may be determined dynamically by the system 100 rather than being fixed or predetermined. This adaptive selection allows the system 100 to balance detection accuracy and power consumption based on real-time system parameters.

At block 402, a video frame is received for analysis. The video frame may be an isolated image from a continuous video stream or a single captured frame, with the frame provided to the video analytics module 126 of system 100 as previously described.

At block 404, a first object-detection algorithm is selected for execution. The selection of the algorithm may be based on predefined rules, historical performance data, or system parameters such as ambient light level of the video stream, any apparent motion in the video stream, or system processor load. For example, a basic object detection algorithm may be selected when processing capacity is otherwise limited, and a higher-precision algorithm may be selected when the video stream or scene is complex, or when a very high level of detection confidence is required.

At block 406, the selected algorithm is executed on the frame (or reduced frame, as described previously) to determine if an object is present. Upon detection of an object, the algorithm preferably provides a confidence score representing the likelihood or probability that the frame (or reduced frame) under analysis contains a valid object.

At block 408, the method determines whether the confidence score of the current object detection algorithm meets a predetermined acceptance threshold. If the score meets or exceeds the threshold, then at block 409 the system determines if there are further detection algorithms available. If no more are available, then at block 414 the detection is confirmed and information identifying the frame (or reduced frame) in which the object was detected is stored locally and/or transmitted to an external storage device. If, at block 408, the confidence score does not meet the threshold then the method ends at block 411, with no object detection confirmed.

If, at block 408, the confidence score does meet the acceptance threshold, and at block 409 further detection algorithms are available, the method continues to block 410 where the system determines the next algorithm to execute. The selection of the next algorithm to execute may be based on information and parameters determined by the currently executing algorithm, such as a low confidence score, detected motion or blur in the frame, or detected occlusion in the frame, and may select a corresponding algorithm designed to compensate for those conditions.

At block 412, the newly selected algorithm is executed on the same (or reduced frame) provided by the previous algorithm to confirm the detection result or to further refine the frame to focus on a likely object.

The process then returns to block 408 where the confidence score is again evaluated, and the process repeats. This iterative selection and evaluation process may repeat until a valid object detection is confirmed (i.e., a desired threshold confidence score is achieved), a maximum number of algorithms have been executed, or another user-determined termination condition is reached.

At block 414, a confirmed detection result is output and/or stored. In some embodiments, the system may also record performance metrics and parameters associated with the object detection process, such as total execution time, power consumption, and the confidence score associated with each executed algorithm in the sequence. These operational metrics and parameters may be used to update or train the selection criteria applied at blocks 404 and 410, thus allowing the process 400 to adapt over time to specific environments or hardware configurations.

The adaptive algorithm selection process thus enables the system to dynamically adjust system resources based on real-time requirements. By using more complex algorithms only when necessary, the process maintains detection accuracy while simultaneously minimizing energy usage. This is particularly advantageous for battery powered systems and implementations.

While the embodiments described above illustrate representative implementations of the system and methods for low-power reduction of false positives in object detection, the invention is not limited to those particular configurations. Various alternative embodiments may be employed, either individually or in combination, to achieve similar functional objectives.

In some alternative embodiments, the object-detection process may be distributed across multiple devices or processing nodes. For example, a first algorithm may execute on a local device (such as system 100) or an embedded processor located in, or in proximity to, a camera, while subsequent confirmation algorithms may be executed on a remote server or a cloud-based analytics platform. The division of processing enables intensive tasks to be offloaded when network conditions allow, thus conserving local power resources.

In other alternative embodiments, specialized hardware accelerator devices such as GPUs or field-programmable gate arrays (FPGAs) may be configured to execute detection algorithms or image preprocessing. Hardware acceleration can reduce the processing time required per frame and allow reduced power operation.

In multi-camera installations, such as the system depicted in FIG. 1, the system may operate in a cooperative mode in which cameras share detection data or confidence scores through a local network, wherein each camera may analyze only its assigned region of interest within its field of view, relying on neighboring cameras for confirmation of detections at the fringes of its field of view.

In other embodiments, individual cameras or systems may share information with other cameras connected to the system and use that shared information in performing object detection. For example, a system may integrate overlapping views from one or more cameras and use the integrated view as a video frame for object detection analysis.

In other embodiments, the system may integrate with existing video management or security systems, with the video analytics module transmitting detection information to the security system.

It should be understood that the components, operations, and sequences described throughout this disclosure may be implemented in varying combinations and configurations. The described processes may be executed concurrently, sequentially, or in partially overlapping fashion. Alternative hardware and software arrangements capable of performing the described functions are within the scope of the present invention.

Thus, it can be seen that the systems and methods described herein provide low-power object detection with reduced false positives. By progressively focusing the object detection analysis on smaller regions of interest and using multiple, independent detection algorithms in succession, the invention significantly reduces redundant analysis and the associated electrical power demand.

1. A video analysis system for low-power object detection with reduced false positives, comprising:
a processor configured to execute computer program instructions;
a memory in communication with the processor and configured to store the computer program instructions and data;
a video analytics module executable by the processor to:
receive a video stream comprising a plurality of video frames;
isolate individual frames from the video stream for analysis;
execute a first object-detection algorithm on a first frame to detect a potential object within the frame;
generate a reduced-size frame corresponding to a region of the first frame in which the potential object was detected;
execute at least one subsequent object-detection algorithm on the reduced-size frame to confirm detection of the object; and
confirm detection of the object based on a composite confidence score of the executed algorithms.

2. The system of claim 1, wherein each subsequently executed object-detection algorithm is different than the preceding algorithm.

3. The system of claim 1, wherein the video analytics module selects a number and type of object-detection algorithms based on at least one of: scene complexity, motion level, illumination, or available power.

4. The system of claim 1, wherein the video analytics module assigns a confidence score to each algorithm output and confirms detection when an aggregate or average confidence score exceeds a threshold.

5. The system of claim 1, wherein the video analytics module reduces redundant analysis by excluding portions of each frame in which no object is detected.

6. The system of claim 1, further comprising a network interface configured to communicate detected object information or confidence scores to an external system.

7. The system of claim 1, further comprising power management circuitry operable to reduce voltage or clock frequency to conserve power in response to reduced frame size.

8. The system of claim 1, wherein the video analytics module is configured to operate with a plurality of cameras that share object detection data or confidence scores.

9. The system of claim 1, wherein the processor comprises a graphics processing unit (GPU).

10. The system of claim 1, wherein the system is implemented as an embedded processor within a camera housing.

11. A computer-implemented method for low-power object detection with reduced false positives, comprising:
receiving, by a processor, a video stream comprising a plurality of video frames;
isolating individual frames from the video stream for analysis;
executing a first object-detection algorithm on a first frame to detect a potential object within the frame;
reducing the frame size to generate a reduced-size frame corresponding to a region in which the potential object was detected;
executing at least one subsequent object-detection algorithm on the reduced-size frame;
assigning a confidence score to each detection result; and
confirming detection of the object based on agreement among the algorithms or a composite confidence score meeting a predetermined threshold.

12. The method of claim 11, further comprising selecting the number and type of algorithms based on real-time parameters including motion level, illumination, or available processing power.

13. The method of claim 11, further comprising adjusting system power parameters based on the size of the analyzed frame or detected computing resources demand.

14. The method of claim 11, wherein each algorithm is executed only on a region of interest identified by a previous algorithm.

15. The method of claim 11, further comprising storing or transmitting confirmed detection results and corresponding confidence scores.

16. The method of claim 11, wherein the first object-detection algorithm and the subsequent algorithm are different algorithms.

17. The method of claim 11, further comprising normalizing video frames to exclude expected background elements from triggering object detection.

18. The method of claim 11, further comprising distributing the execution of object-detection algorithms between local and remote computing systems to reduce local power consumption.

19. The method of claim 11, wherein each subsequent algorithm generates a smaller reduced-size frame until object detection is confirmed or a predetermined maximum number of algorithms is executed.

20. The method of claim 11, further comprising recording operational parameters including total execution time, power usage, and confidence scores.
